(19) United States
(12) Patent Application Publication
(10) Pub. No.: US 2010/0170727 A1
(43) Pub. Date: Jul. 8, 2010

(54) HYBRID-POWERED ZERO-EMISSION VEHICLE USING HUMAN, ELECTRIC, AND SOLAR POWER INPUTS

(75) Inventors: Tai-Ran Hsu, Sunnyvale, CA (US); Raymond K. Yee, Castro Valley, CA (US); Thuy T. Le, Fremont, CA (US)

Correspondence Address: IPxLAW Group LLP, 95 South Market Street, Suite 570, San Jose, CA, 95113, US

(73) Assignee: SAN JOSE STATE UNIVERSITY RESEARCH FOUNDATION, San Jose, CA (US)

(21) Appl. No.: 12/631,754

(22) Filed: Dec. 4, 2009

Related U.S. Application Data
(60) Provisional application No. 61/201,046, filed on Dec. 4, 2008.

(51) Int. Cl. B60K 16/00; B60L 8/00

(52) U.S. Cl. 180/2.2

(57) ABSTRACT

The present invention is directed to a vehicle that can be powered via integrated power systems involving human pedaling, electric and solar energy, a wheel drive power transmission system for the vehicle that can also operate in reverse direction, and an integrated solar/electric power system for mobile systems. The unique design for vehicle power transmission systems enables human pedaling and electric motor to power the vehicle independently. The electric motor is powered by batteries charged by either or both household 11.0 VAC plug-in sources and the solar panels integrated to the exterior of the vehicle.

This application claims priority to our prior filed U.S. Provisional Application Ser. No. 61/201,046 filed Dec. 4, 2008, entitled “A HYBRID-POWERED ZERO-EMISSION VEHICLE USING HUMAN, ELECTRIC, AND SOLAR POWER INPUTS” which is expressly incorporated in its entirety herein.

### FIELD OF THE INVENTION

The invention relates generally to hybrid-powered vehicles. More particularly, the invention relates to a hybrid-powered zero-emission vehicle using human, electric, and solar power inputs.

### SUMMARY

The environmental problems of pollution and global greenhouse gas emissions can be substantially attributed to the transportation sector, Non-renewable energy sources, such as gasoline and diesel, are the primary sources to power transport vehicles used throughout the world. In addition to being gross polluters, gasoline or diesel-powered vehicles are also often cumbersome in crowded urban settings, particularly in the developing world. Large gas or diesel-powered vehicles are also often expensive and unaffordable to many people.

Low emission vehicles powered by renewable energy sources currently exist and are being developed to avoid the pollution, traffic, and economic problems associated with large gas or diesel-powered vehicles. For example, traditional human-powered vehicles, such as bicycles, are commonly used for daily commute and transport, particularly in developing countries.

Human-powered vehicles have no financial energy costs and are always available. However, they have very low cruising speed, short ranges, and limited carrying capacity. Emission free electric-powered vehicles have also been developed, however, they use heavy batteries with limited cruising ranges. Solar-powered vehicles provide a clean alternative to vehicles powered by non-renewable energy sources. However, solar vehicles generally have a low power density and solar energy is not always available. Furthermore, electric and solar-powered vehicles are often expensive and unaffordable for many people.

The present invention is directed to a hybrid vehicle having multiple power inputs, including human power and an electric motor. Human power drives the vehicle through pedals and the electric motor is driven by a combination of one or more batteries and solar photovoltaic panels on the vehicle. In a preferred embodiment of the invention, one or more of the batteries can be recharged by the solar panels on the vehicle and/or by the electric grid, such as through a household electrical outlet. The affordable and environment-friendly hybrid vehicle of the present invention is well suited for low speed urban transport, though the hybrid vehicle can be used for any application.

In an embodiment of the hybrid vehicle of the present invention, the human-powered pedals and the electric motor drives the same power shaft to turn the wheels on the vehicle. The source or sources that drive the power shaft can be manually adjusted through a switch or the power source can be automatically adjusted. The hybrid vehicle is also capable of forward and reverse driving. A reverse clutch is provided in certain embodiments to prevent the pedals from turning when the electric motor drives the vehicle in the reverse direction.

It is important to note that in a preferred embodiment, the hybrid vehicle includes a data to processing unit (DPU) and a data acquisition system (DAS). The DPU and DAS control the charging/recharging properties of the batteries and/or the driving properties of the vehicle. Charging/recharging properties can include the energy source used to charge the batteries (e.g. solar panels versus outlet) and the amount or rate of charging. Driving properties can include the source of power to the power shaft (e.g. human pedaling versus the electric motor) and the amount of power applied. Preferably, the charging/recharging and/or driving properties are based on the condition of the batteries, the operation status of the vehicle, the current supplied by the solar panels, user-provided data, or any combination thereof. In an embodiment, the source of power to drive the vehicle is automatically determined based on the speed of the vehicle relative to a threshold speed. For example, when the vehicle is moving less than the threshold speed, it is only powered by human pedaling. Once this threshold speed is exceeded, the electric motor engages the power shaft. It is important to note that the threshold speed is adjustable and programmable.

### DESCRIPTION OF THE INVENTION

The invention relates to a hybrid clean powered vehicle (HCPV) (or ZEM vehicle) that can be driven by a hybrid integrated power sources of human pedaling, electricity and solar energies. The word “ZEM” in the title of the invented vehicle stands for “Zero EMission”.

Human pedaling can be used to start and drive the vehicle at low speed whereas electric motors powered by electricity supplied by batteries can drive the vehicle at a higher speed. The batteries are charged by the solar energy harnessed by the solar panels that are integrated to the exterior surfaces of the chassis of the vehicle. Solar energy can charge the batteries when the vehicle is in operations, or in idle mode with exposure to the sunlight.

Today's electrical powered vehicles are emission-free and they are environmentally friendly. However, they are required to carry a large number of batteries in order to provide sufficient power to drive a vehicle running at a practical speed, and for reasonable cruising ranges. Unfortunately most of the batteries used in electric vehicles are heavy. They become a burden of dead load to the vehicle after they are consumed and depleted. There is no known electric vehicle with a provision for continuously charging its batteries while being depleted in ongoing operations.

The subject invention of the hybrid powered ZEM vehicle is uniquely designed to offer a viable option for propulsion by human pedaling at low speed in order to conserve the electric energy stored in the batteries. An on-board electric motor, with power supplied by the batteries, drives the vehicle at higher speeds. The integrated solar photovoltaic panels can convert the collected solar energy into electricity and provide charging of batteries through a charging controller at all times. Charging of batteries continues while the vehicle is either idling or parked in open space to the sky. The hybrid power system is designed to have the batteries either charged by solar power generated from the attached solar panels, or by the household 110-VAC outlet from utility grid power lines.

The uniquely designed integrated power sources of human pedaling and solar panels for the ZEM vehicle have the benefit of significantly reducing the number of batteries required to power an electrically powered vehicle, as well as they can effectively extend the vehicle's cruising range.

Utility: The ZEM vehicle is designed and constructed for transportation in urban centers. Transportation in these urban centers is typically characterized by: 1) low speed with frequent stops, 2) traveling short distances, 3) single or dual riders, 4) nominal cargo capacity, 5) crowded streets with heavy pedestrian and vehicle traffic, 6) narrow streets with limited parking space, and 7) significant noise and air pollution.

The ZEM vehicle is specially suited for the aforementioned urban settings, though the ZEM vehicle can be operated in any setting. The vehicle is designed to carry typically one driver and a passenger. Both or either of the driver and the passenger can pedal the vehicle to run at low speed in crowded streets with heavy pedestrian and vehicle traffic. The driver may switch to the motor-driven mode for the vehicle to attain a higher speed in lighter traffic zones. The supplementary solar energy can charge the batteries at all times at all speeds. Human pedaling conserves energy, and the other power source of solar energy provides effective use of clean and renewable energy to supplement the driving power of the vehicle. The ZEM vehicle does not burn fossil fuels such as gasoline or diesel fuel, and it is free of noise and air pollution.

The innovative design of the ZEM vehicle involves integrated human pedaling, electricity and solar energy as hybrid source of power to drive a vehicle.

In the Drawings

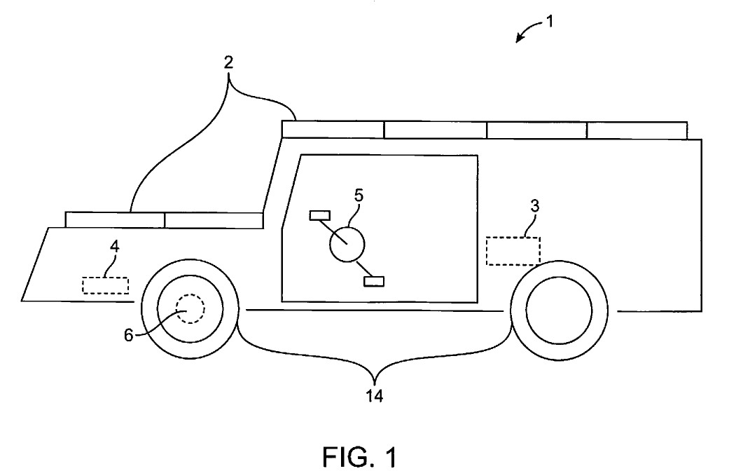

FIG. 1, a side view of a hybrid human pedaling, electric and solar energy vehicle;

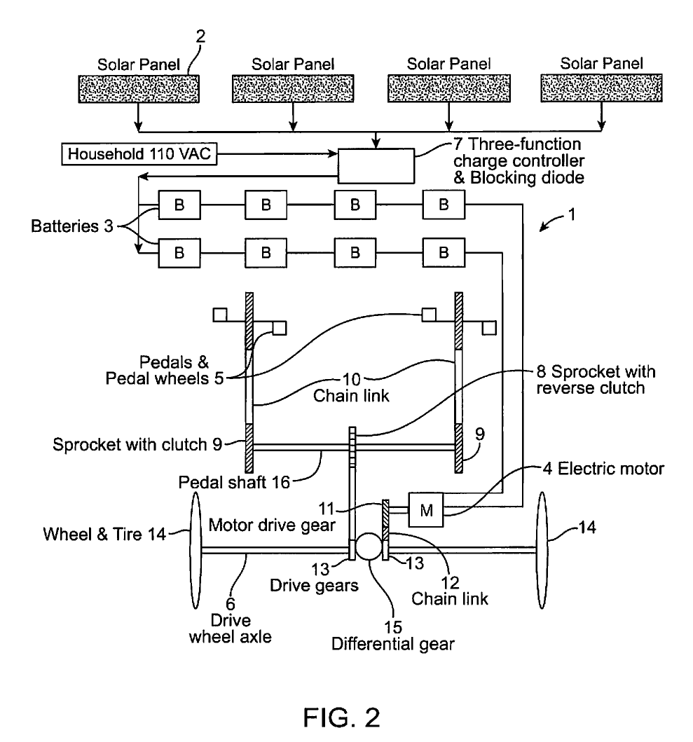

FIG. 2 depicts the drive system that integrates the power supplied by human pedaling and electricity for the ZEM vehicle;

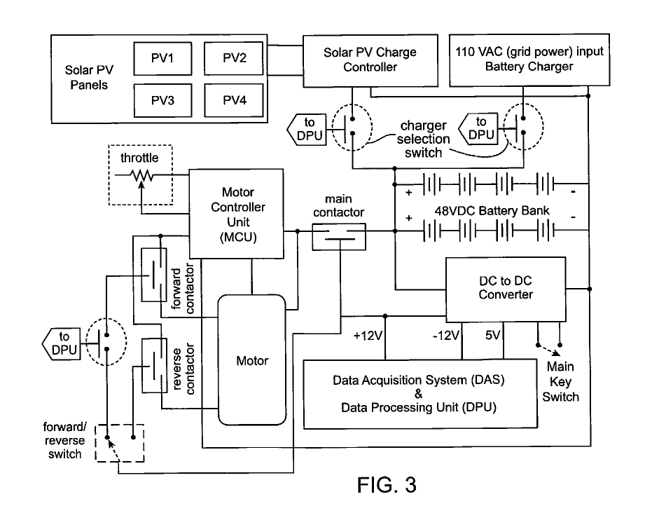

FIG. 3 is a simplified schematic of the electrical system; and

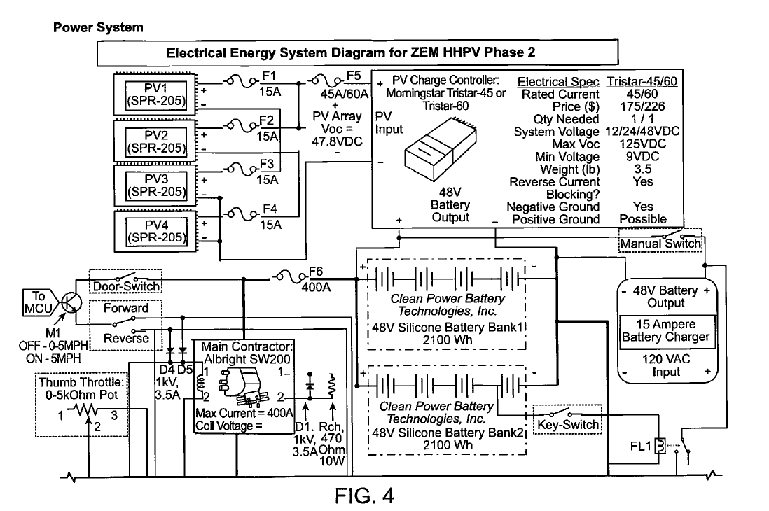

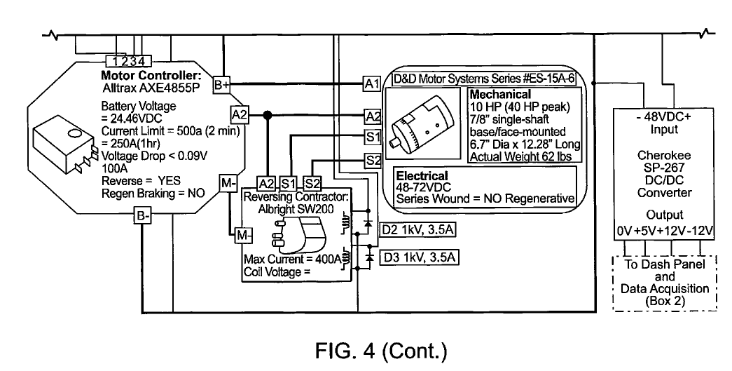

FIG. 4 is a more detailed schematic of the electrical system

### DETAILED DESCRIPTION

Turning to FIG. 1, a side view of a hybrid human pedaling, electric and solar energy vehicle (1) is shown. Solar photovoltaic panels (2) are integrated to the exterior surface of the chassis of the vehicle. The electricity produced by these panels is stored in sets of batteries (3) inside the vehicle. These batteries can also be charged by electric power from household 110-volt electric outlets. The vehicle (1) can be driven by wheels (14) attached to a specially designed drive axle (6), either by human pedaling (5) or by the electric motor (4) adjacent to the drive axle.

FIG. 2 depicts this drive system that integrates the power supplied by human pedaling (5) and electricity for the ZEM vehicle (1). The source of electric power is the sets of batteries (3) that can be charged by both household 110 VAC outlets and the electricity generated by solar photovoltaic panels (2) through the use of multi-functional charge controller and blocking diodes (7). A special pedal shaft (16) is designed. to accommodate driving power inputs from human pedaling through chain link (10) to the sprockets with built-in clutch (9) and from the electric motor (4) through a motor drive gear (11). The latter gear (11) is used to drive the vehicle through a chain link (12) and the drive gear (13), which turns the wheels (14) of the vehicle. A differential, gear (15) is used in the drive wheel axle (6).

The design of a vehicle drive system that integrates human, electric and solar power for vehicle can run the vehicle in both forward and backward directions. The motor (4) in the drive system described in FIG. 2 can rotate in reverse direction, which can drive the vehicle (1) to move in the backward direction. However, such movement prompts the sprockets (9) that connected to the pedal wheels (5) to rotate at the reverse direction too, which is not desirable to the riders of the vehicle. In an embodiment of the invention, a reverse clutch is installed in the sprocket (8) attached to the pedal shaft (16) as shown in. FIG. 2.

This reverse drive clutch in the sprocket (8) is engaged during the vehicle's forward moving direction. The clutch is disengaged during the reverse motion of the vehicle (1). In such case, the reverse rotation of the drive wheel axle (6) will not cause rotation of the pedal shaft (16). The pedal. wheels (5) thus will not be affected during the reverse motion of the vehicle.

The electric system as shown generally in FIG. 3 and more specifically in FIG. 4 includes 8 batteries connected in series and parallel to make up 48VDC. This 48VDC is the only direct electrical power source for whole vehicle. These batteries can be recharged by 110 VAC outlet (Grid) or can be recharged by a solar photovoltaic (PV) panel system installed on the exterior surface of the vehicle. The solar panel system can recharge the batteries anytime that the solar system can generate current (sunlight). The current design has a manual switch to select 110 VAC charger (Grid charger) or solar charger (PV charger). However, the vehicle batteries can be recharged by one or both systems at the same time as desired by the drivers. The special design in this recharge system is from the charger selection switch. The switches are on/off by voltage supplied to the bases of the two electronic switches. This kind of design is also applicable for an option of having the switch powered by the vehicle data processing unit (DPU), base on the condition of the batteries, the operation status of the vehicle, the electrical current supplied from the solar system, and possible data provided by the driver. A special data acquisition. system (DAS) is developed, specifically for the ZEM vehicle. This DAS together with the Data Processing Unit (DPU) can decide to automatically switch to PV charger, Grid charger, or both. The DPU is designed as a digital system with a microcontroller and several peripherals and circuits. The digital system is programmable as desired by vehicle owners.

A Motor Controller Unit (MCU) controls the electric motor that powers the vehicle. The MCU provides required voltage to the motor via the throttle, which is used to control the vehicle speed. Forward or reverse driving can be selected by a forward/reverse manual switch. This switch supplies I2 VDC to the forward and reverse contactors, which are used to switch the voltage polarity to the motor. The I2 VDC-supplied voltage to the forward contactor is also controlled by the vehicle DPU. Supplying voltage to the forward contactor by the manual forward/reverse switch only can be done when the vehicle has reached a certain speed (threshold speed) as programmed. This kind of design will give the drivers option of powering the vehicle at low speeds (e.g. below 5 MPH) by human pedaling and then continue to power the vehicle with electric power for higher speed. The threshold speed is adjustable by an assembly program that is used for the vehicle data processing unit. In certain embodiments, the speed threshold switch is bypassed for simple implementation.

### FEATURES OF THE INVENTION

1: The innovative design of the ZEM vehicle that involves integrated human pedaling, electricity and solar energy as hybrid source of power to drive a vehicle. A dual power transmission system uses in the ZEM vehicle employs one common drive axle which can accept two separate power inputs, one from human pedaling and the other from an electric motor. The front wheel drive axle consists of two power transmitting sprockets which are integrated into the differential housing of the vehicle. One of the sprockets connects to the electric motor and the other sprocket connects to the pedal input shaft. Friction clutches are integrated into the sprocket hubs mounted at the pedal input shaft which allows for direct power transmission from human pedaling at low speed (about 5 to 7 miles per hour). When the driving power of the vehicle is switched from human pedaling power to electric motor power, the clutches disengage and the pedal input shaft behaves like a free wheel. The arrangement of a single driving axle with manual/automatic engagements of dual human power and motor power input system provides smooth transitions of hybrid driving power between one or two drivers and electric power driving. (Key features are illustrated in FIG. 2)

2: The design of a forward and reverse vehicle drive system that integrates human, electric and solar power The power transmission of the vehicle is capable of reversing the rotation of the drive axle for vehicle backup. During vehicle backup operation, the drive axle powered by the electric motor in reverse direction would not mobilize the human pedaling wheels at the passenger compartment. This accomplished by integrating a reverse friction clutch into the hub of the central sprocket (8) to the pedal shaft (16) in FIG. 2.

3: Electric batteries in the vehicle can be charged or recharged by 11 OVAL outlet (Grid) or can be recharged by a solar photovoltaic (PV) panel system installed on the exterior surface of the vehicle. The solar panel system can recharge the batteries anytime that the solar system can generate current from the sunlight. The vehicle batteries can be recharged by grid line power supply or both solar panels at the same time as desired by the drivers. The current design has a manual switch to select 1 IOVAC charger (Grid charger) or solar charger (PV charger). The special design in this recharge system is from the charger selection switch.

4: The battery charge switches operate on on/off by supplied voltage to the bases of the two electronic switches. Base on the condition of the batteries, the operation status of the vehicle, the electrical current supplied from the solar system, and possible data provided by the driver, the data processing unit will decide to automatically switch to PV charger, Grid charger, or both. The vehicle data acquisition system and data processing unit are designed as digital systems with a microcontroller and number of sensors, peripherals, and circuits.

5. The forward contactor is in fact on/off by a switch operated by supplied voltage to the base of an electronic switch. This supplied voltage is controlled by the vehicle data processing unit that the voltage will be provide once the vehicle has reached a certain speed (threshold speed) as programmed.

6. A data processing unit allows the driver to program the adjustable threshold speed to automatically prompt the electric powered operations from human pedaling. Also it can automatically switch from 110 VAC grid power charging to solar power, or from both sources to charging the vehicle batteries.

What is claimed is:

1. A hybrid vehicle, comprising:
a chassis:
a plurality of wheels rotatably mounted to the chassis and operative to rollingly support the vehicle;
a pedal assembly driveably coupled to at least one of the wheels for enabling application of human drive power to the wheel;
an electric motor coupled to at least one of the wheels for applying electrical drive power to the wheel;
a dual power transmission system for enabling power application to the wheel from the pedal assembly and/or the electric motor;
an electrical energy storage means for selectively providing electrical power to the motor;
solar power generating means for supplying charging current to the energy storage means; and
a control system for controlling the application of solar power to the energy storage means and for allowing a vehicle operator to select either human pedal power or electric motor drive power or both for application to the wheel.
